(19) United States
(12) Patent Application Publication
(10) Pub. No.: US 2011/0271257 A1
(43) Pub. Date: Nov. 3, 2011

(54) DEFECT MANAGEMENT IN INTEGRATED DEVELOPMENT ENVIRONMENTS

(75) Inventors: Benjamin Terris, Tucson, AZ (US); Richard A. Welp, Tucson, AZ (US)

(73) Assignee: INTERNATIONAL BUSINESS MACHINES CORPORATION, Armonk, NY (US)

(21) Appl. No.: 12/769,766

(22) Filed: Apr. 29, 2010

(51) Int. Cl. G06F 9/44

(52) U.S. Cl. 717/125

(57) ABSTRACT

A method for managing defects in an integrated development environment is disclosed herein. In one embodiment, such a method includes identifying one or more files associated with a defect. These one or more files may then be linked to the defect using a tag or other suitable linking mechanism. Once the files are linked to the defect, the method may allow the defect to be selected from a defect list. The files associated with the defect are optionally displayed upon selecting the defect. The method further enables an action to be selected for one or more of the files associated with the defect in the defect list. The method then automatically performs the action on the one or more files. A corresponding apparatus and computer program product are also disclosed herein.

### BACKGROUND

1. Field of the Invention

This invention relates to apparatus and methods for managing defects in integrated development environments.

2. Background of the Invention

In a typical integrated development environment (IDE), a developer may have several files open concurrently, all of which may be associated with a certain problem or defect (also referred to herein as a “bug”). When working on one problem, it is common for a new, higher priority problem to be called to a developer's attention. To work on this new problem, the developer may have to put aside the problem that he or she is currently working on and turn his or her attention to the new, higher priority problem. To do so, the developer may have to redirect his or her attention from a current set of files to a completely new set of files associated with the new defect. This may involve closing the current set of files and opening up a new set of files, or alternatively, opening the new set of files concurrently with the old set of files. In certain cases, each file may need to be opened and closed individually. Because a large number of files may be associated with any particular problem or defect, this can be a very time-consuming and laborious process.

Once the developer has finished addressing the higher priority problem, the developer may need to dedicate time to regroup and remember where he or she left off with the previous problem. In certain cases, this may involve locating and opening all of the files that were previously closed to address the more urgent problem. This can significantly reduce the developer's productivity. Other productivity issues may also arise during this process, such as forgetting about a file completely and/or not checking in a critical piece of code after it has been modified. This may lead to problems down the road where a problem is forgotten and assumed to be fixed.

In view of the foregoing, what are needed are apparatus and methods to enable a developer to more efficiently work on multiple problems or defects. Ideally, such apparatus and methods would allow the developer to turn his or her attention to a new, higher priority problem and, once the problem is addressed, quickly regroup and resume work on a previous problem. Further needed are apparatus and methods that will allow the developer to easily determine which files are associated with a particular problem or defect, know the status of each of these files, and perform actions on each of these files either individually or as a group.

### SUMMARY

The invention has been developed in response to the present state of the art and, in particular, in response to the problems and needs in the art that have not yet been fully solved by currently available apparatus and methods. Accordingly, the invention has been developed to provide apparatus and methods to manage defects within an integrated development environment. The features and advantages of the invention will become more fully apparent from the following description and appended claims, or may be learned by practice of the invention as set forth hereinafter.

Consistent with the foregoing, a method for managing defects in an integrated development environment is disclosed herein. In one embodiment, such a method includes identifying one or more files associated with a defect. These one or more files may then be linked to the defect using a tag or other suitable linking mechanism. Once the files are linked to the defect, the method may allow the defect to be selected from a defect list. The files associated with the defect are optionally displayed upon selecting the defect. The method further enables an action to be selected for one or more of the files associated with the defect in the defect list. The method then automatically performs the action on the one or more files.

A corresponding apparatus and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a flow diagram showing one embodiment of a method for managing defects in an integrated development environment;

FIG. 2 is a diagram showing one contemplated embodiment of a file panel providing the ability to link files to defects;

FIG. 3 is a diagram showing one contemplated embodiment of a defect panel for displaying a list of defects;

FIG. 4 is a diagram showing the defect panel and its ability to list files associated with a defect;

FIG. 5 is a diagram showing the defect panel and the ability to show the status of files associated with a defect;

FIG. 6 is a diagram showing the defect panel and the ability to perform actions on one or more files associated with a defect; and

FIG. 7 is a high-level block diagram showing one embodiment of a defect management module in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, the present invention may take the form of a hardware embodiment, a software embodiment (including firmware, resident software, microcode, etc.) configured to operate hardware, or an embodiment combining software and hardware aspects that may all generally be referred to herein as a “module” or “system.” Furthermore, the present invention may take the form of a computer-usable storage medium embodied in any tangible medium of expression having computer-usable program code stored therein.

Any combination of one or more computer-usable or computer-readable storage medium(s) may be utilized to store the computer program product. The computer-usable or computer-readable storage medium may be, for example but not limited to, an electronic, magnetic, optical, electromagnetic, infrared, or semiconductor system, apparatus, or device. More specific examples (a non-exhaustive list) of the computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable storage medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, may be implemented by computer program instructions or code. The computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

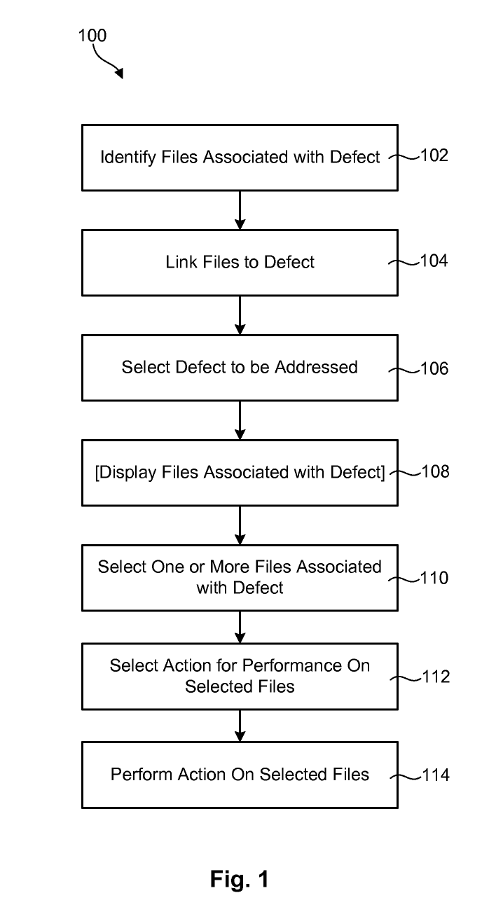

Referring to FIG. 1, one embodiment of a method 100 for managing defects in an integrated development environment (IDE) is illustrated. In certain embodiments, such a method 100 may be implemented in an IDE (such as the Eclipse IDE) that communicates with a bug-tracking system (such as IBM's CMVC bug-tracking system). Nevertheless, the method 100 (and apparatus) disclosed herein are not inherently tied to any particular IDE or bug-tracking system, but may be adapted to work with any combination of the two.

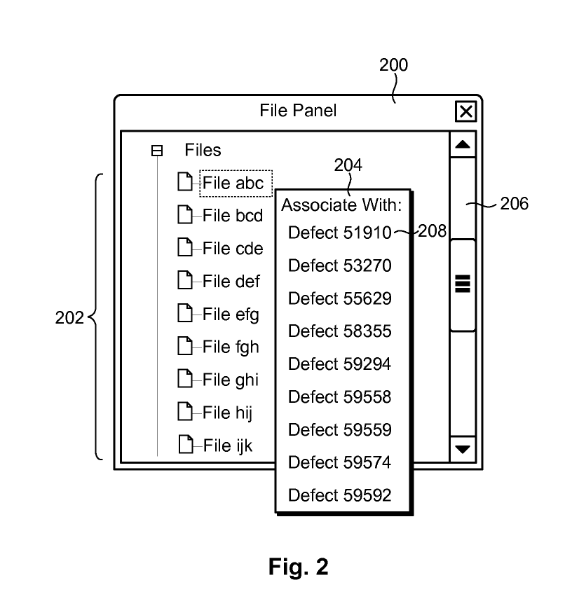

As shown, the method 100 initially identifies 102 one or more files that are associated with a defect. As will be appreciated by one skilled in the art, various different types of files as well as different numbers of files, one or more of which may require modification, may be associated with a particular software bug or defect. Once the files that are associated with a defect are identified 102, the method 100 links 104 the files to the defect. One example of a graphical user interface (GUI) for performing this linking operation will be discussed in association with FIG. 2.

Once one or more files are linked 104 to the defect, the method 100 may enable the defect to be selected 106 from a defect list. This defect list may, in certain embodiments, display all defects that have been assigned to a particular developer and/or are currently pending and waiting for a fix. Upon selecting 106 the defect, the method 100 may optionally display 108 the files that were linked to the defect during the linking step 104. The method 100 then allows a developer to select 110 one of more files associated with the defect. Once the one or more files are selected 110, the method 100 allows the developer to select 112 an action to perform on the one or more files. The method 100 may then perform 114 the action on the selected files.

Referring to FIG. 2, one example of a graphical user interface, also referred to herein as a “file panel” 200, is illustrated. This file panel 200 displays files and provides the capability to link the files to defects. In certain embodiments, the file panel 200 or a similar panel or GUI may be integrated with an IDE's GUI using a plug-in or code for extending the functionality of the IDE. As shown, in certain embodiments the file panel 200 may display a list 202 of files associated with a software project. A scroll bar 206 may optionally allow a developer to scroll through files in the file panel 200.

The file panel 200 may allow a developer to select one or more files from the file list 202 that are associated with a particular defect. These files may be selected individually, such as by selecting a particular file by clicking on it with a mouse pointer, or as a group, such as by clicking on multiple files while holding down the “Control” or “Shift” key. Once the desired files are selected, the files may be linked to one or more defects. This may be accomplished for example, by right clicking the selected files (which may cause a context menu 204 to appear) and then selecting the particular defects in the context menu 204 with which to associate the files. In certain embodiments, tags (such as defect numbers 208) may be applied to the files to link them to particular issues or defects. These tags and file associations may be recorded in simple databases, flat file structures, or other suitable data structures. Tag entries may be stored in the data structures along with their associated files. In certain embodiments, files may be defined by their location within the integrated development environment.

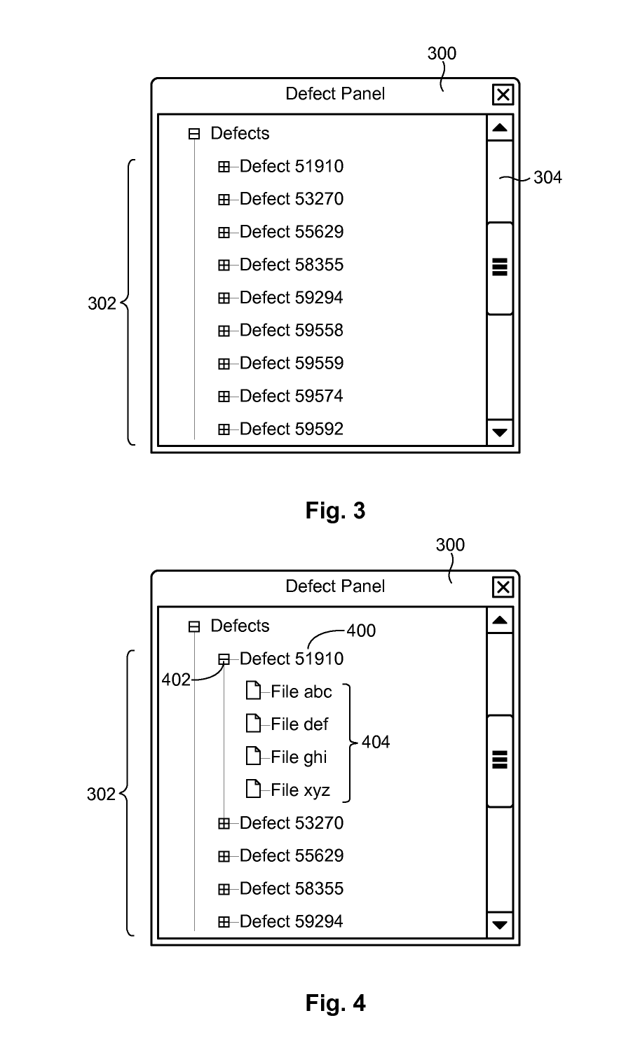

Referring to FIG. 3, one example of a graphical user interface, also referred to herein as a “defect panel” 300, is illustrated. Like the file panel 200, the defect panel 300 may be integrated into an IDE's GUI using a plug-in or other program code for extending the functionality of the IDE. As shown, the defect panel 300 may display a list 302 of defects. In certain embodiments, the defect panel 300 is populated with defects by logging in and querying a bug-tracking system either on the developer's computer or on a local or remote server. The defect panel 300 may also in certain embodiments enable a developer to create new defects. A scroll bar 304 may allow the developer to scroll through defects in the defect panel 300. In certain embodiments, the defects in the defect list 302 include those that have been assigned to a particular developer and/or are currently pending and waiting for a fix. In certain embodiments, each defect may be assigned a defect number or other unique identifier.

In certain embodiments, the defect panel 300 may allow a developer to view all files that are associated with a particular defect. For example, as shown in FIG. 4, selecting a defect (such as by clicking on the defect number 400 or on an expand/collapse button 402 associated with the defect) may cause a list 404 of files associated with the defect to appear. These files 404 may, in certain embodiments, appear as sub-entries of the defects 400. This may allow a developer to select the files individually, such as by selecting a particular file by clicking on it, or select a group of files, such as by clicking on multiple files while holding down the “Control” or “Shift” key. Actions (e.g., opening, closing, saving, checking in, checking out, etc.) may then be performed on the files either individually or as a group.

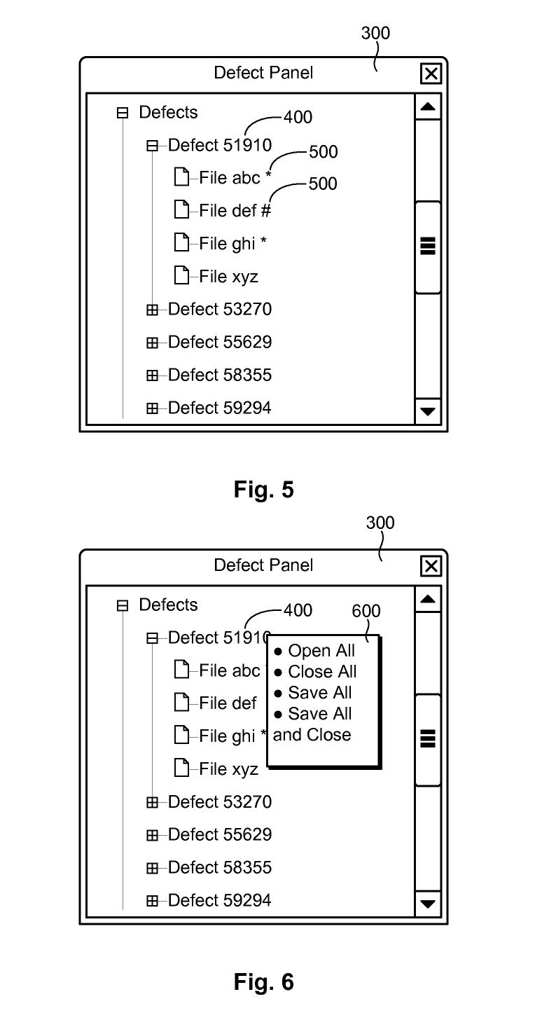

Referring to FIG. 5, in selected embodiments, visual status indicators 500 may be displayed for one or more files associated with a defect. For example, as shown in FIG. 5, a “*” symbol may indicate that the file has been modified and is awaiting check-in, and a “#” symbol may indicate that the file has been changed and has already been checked in. The absence of a symbol may indicate that the file is still waiting to be modified. Other status indicators 500 are also possible and within the scope of the invention. In this way, a developer may quickly see the status of each file associated with a particular defect. This may help a developer quickly regroup and remember where he or she left off when previously working on the defect. In certain embodiments, the status information for each file is stored in the database, flat file structure, or other data structure previously described.

Referring to FIG. 6, in selected embodiments, the defect panel 300 may allow a developer to perform actions on files individually or as a group. In certain embodiments, the defect panel 300 may provide the option to perform an action on all files associated with a particular defect. For example, right clicking on a defect identifier 400 may cause a context menu 600 to appear. The developer may then select an action to perform on all files associated with the defect. For example, the developer may choose to open all files, close all files, save all files, save all files and close, check-in all files, check-out all files, or the like. Other menu options are also possible and within the scope of the invention. Such an action may also be performed on a subset of the files associated with the defect. For example, a developer may select several files associated with a defect by holding down the “Control” key and clicking on the several files with the mouse pointer. The developer could then right click on the selected files to reveal a context menu 600 similar to that illustrated in FIG. 6. Any of the options previously discussed could then be selected for the files as a group. This ability to select and perform operations on all files or groups of files associated with a defect may significantly increase developer productivity by eliminating the need to locate files and perform actions on the files individually.

One of skill in the art will recognize that the GUI panels 200, 300 illustrated in FIGS. 2 through 6 may be modified in various ways without departing from the principles taught herein. For example, the size, configuration, and organization of the GUI panels 200, 300 may be modified as needed. Different types of GUI widgets may be suitable for displaying files, defects, and actions as well as selecting the files, defects, and actions. Other methods for showing the status of the files are also possible. Thus, the GUI panels 200, 300 and widgets 204, 600 shown in FIGS. 2 through 6 are presented only by way of example and are not intended to be limiting.

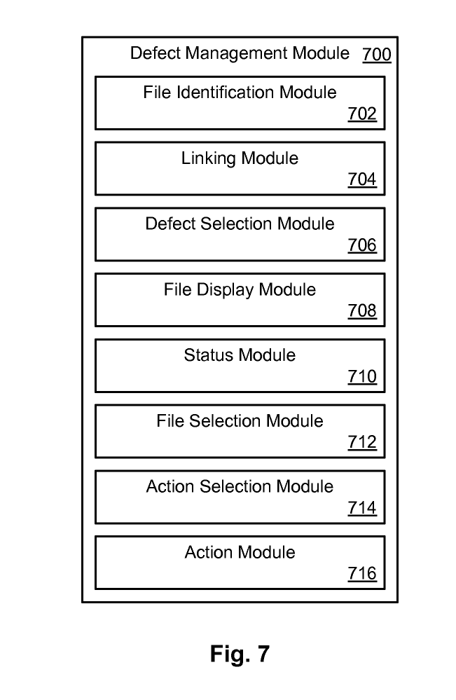

Referring to FIG. 7, in certain embodiments, a defect management module 700 in accordance with the invention may be configured to provide all or part of the functionality described in FIGS. 1 through 6. This defect management module 700 may contain one or more modules to provide various features and functions. These modules may be implemented in hardware, software or firmware executable on hardware, or a combination thereof. The modules are presented only by way of example and are not intended to be limiting. Indeed, alternative embodiments may include more or fewer modules than those illustrated. Furthermore, it should be recognized that, in some embodiments, the functionality of some modules may be broken into multiple modules, or conversely, the functionality of several modules may be combined into a single module or fewer modules. It should also be recognized that the modules are not necessarily implemented in the locations where they are illustrated. For example, functionality shown in the defect management module 700 may actually be contained in other modules. Thus, the location of the modules is presented only by way of example and is not intended to be limiting.

As shown, the defect management module 700 may, in certain embodiments, include one or more of a file identification module 702, a linking module 704, a defect selection module 706, a file display module 708, a status module 710, a file selection module 712, an action selection module 714, and an action module 716, among other modules. The file identification module 702 may allow a developer to identify one or more files that are associated with a defect. This may be accomplished, for example, using the file panel 200 illustrated in FIG. 2, although other methods are also possible. Once the files are identified, a linking module 704 may allow the developer to link the files to the defect. For example, the developer may accomplish this using the context menu 204 illustrated in FIG. 2, although other techniques or GUI widgets are also possible to perform this function.

Once a link is created between one or more files and a defect, a defect selection module 706 may allow the developer to select the defect from a defect list. One embodiment of a defect list 302 is illustrated in FIG. 3. A display module 708 may optionally display the files that are linked to the defect when it is selected. Likewise, a status module 710 may optionally display a status for one or more of the files. Each time the status of a file changes, the status module 710 may update the status. To perform actions on one or more of the files, a file selection module 712 may allow one or more of the files associated with a defect to be selected. An action selection module 714 may then allow one or more actions (e.g., opening, closing, saving, checking in, checking out, etc.) to be selected for the files. An action module 716 may then perform the actions on the files.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for managing defects within an integrated development environment, the method comprising:
identifying a plurality of files associated with a defect;
linking the plurality of files to the defect;
enabling the defect to be selected from a defect list;
enabling an action to be selected for at least one file associated with the defect in the defect list; and
automatically performing the action on the at least one file.

2. The method of claim 1, further comprising displaying the at least one file upon selecting the defect from the defect list.

3. The method of claim 2, wherein displaying further comprises indicating a status of the at least one file.

4. The method of claim 3, wherein the status comprises at least one of: checked out, checked in, already modified, and not modified.

5. The method of claim 4, wherein automatically performing the action on the at least one file further comprises updating the status of the at least one file.

6. The method of claim 1, wherein the at least one file comprises all files associated with the defect in the defect list.

7. The method of claim 1, wherein the action comprises at least one of: opening the at least one file, closing the at least one file, checking in the at least one file, checking out the at least one file, and saving the at least one file.

8. A computer program product to manage defects within an integrated development environment, the computer program product comprising a computer-usable storage medium having computer-usable program code embodied therein, the computer-usable program code comprising:
computer-usable program code to identify a plurality of files associated with a defect;
computer-usable program code to link the plurality of files to the defect;
computer-usable program code to enable the defect to be selected from a defect list;
computer-usable program code to enable an action to be selected for at least one file associated with the defect in the defect list; and
computer-usable program code to automatically perform the action on the at least one file.

9. The computer program product of claim 8, further comprising computer-usable program code to display the at least one file when the defect is selected from the defect list.

10. The computer program product of claim 9, further comprising computer-usable program code to indicate a status of the at least one file when it is displayed.

11. The computer program product of claim 10, wherein the status comprises at least one of: checked out, checked in, already modified, and not modified.

12. The computer program product of claim 11, further comprising computer-usable program code to update the status of the at least one file when the action is performed on the at least one file.

13. The computer program product of claim 8, wherein the at least one file comprises all files associated with the defect in the defect list.

14. The computer program product of claim 8, wherein the action comprises at least one of: opening the at least one file, closing the at least one file, checking in the at least one file, checking out the at least one file, and saving the at least one file.

15. An apparatus to manage defects within an integrated development environment, the apparatus comprising:
a file identification module to identify a plurality of files associated with a defect;
a linking module to link the plurality of files to the defect;
a defect selection module to enable the defect to be selected from a defect list;
an action selection module to enable an action to be selected for at least one file associated with the defect in the defect list; and
an action module to automatically perform the action on the at least one file.

16. The apparatus of claim 15, further comprising a display module to display the at least one file when the defect is selected from the defect list.

17. The apparatus of claim 16, further comprising a status module to indicate a status of the at least one file when it is displayed.

18. The apparatus of claim 17, wherein the status comprises at least one of: checked out, checked in, already modified, and not modified.

19. The apparatus of claim 15, wherein the at least one file comprises all files associated with the defect in the defect list.

20. The apparatus of claim 15, wherein the action comprises at least one of: opening the at least one file, closing the at least one file, checking in the at least one file, checking out the at least one file, and saving the at least one file.
